(19) United States
(12) Patent Application Publication
(10) Pub. No.: US 2009/0021836 A1
(43) Pub. Date: Jan. 22, 2009

(54) INTERMEDIATE PRODUCT IN THE MANUFACTURE OF LIGHT SOURCES WITH OPTICAL FRONT BEAM GUIDING ELEMENTS TO CONSTRICT THE BEAM DIVERGENCE AND/OR TO FORM THE BEAM OF LIGHT EMITTERS

(75) Inventor: Dieter Koch, Zirndorf (DE)

Correspondence Address: BROWDY AND NEIMARK, P.L.L.C.;624 NINTH STREET, NW, SUITE 300, WASHINGTON, DC, 20001-5303, US

(73) Assignee: Eschenbach Optik GmbH, Nurnberg (DE)

(21) Appl. No.: 12/162,481

(22) PCT Filed: Jan. 26, 2007
(86) PCT No.: PCT/DE07/00161

§ 371 Date: Jul. 28, 2008

(30) Foreign Application Priority Data
Jan. 26, 2006 (DE) 10 2006 003 720.0
Jan. 24, 2007 (DE) 10 2007 004 579.6

(51) Int. Cl. G02B 27/10

(52) U.S. Cl. 359/619

(57) ABSTRACT

An intermediate product is used in the manufacture of light sources with optical front beam guiding elements to constrict the beam divergence of light emitters. The intermediate product has multiple front beam guiding elements and a support, to which the front beam guiding elements are fixed in a defined order. An optical front beam guiding element is implemented so that it can be attached to each light emitter. The support consists of a stronger, more rigid material, compared with the material of the front beam guiding elements. The result is an intermediate product which allows processing of even expensive materials for front beam guiding elements and, because of its special suitability for automated further processing steps, has cost advantages.

The invention concerns an intermediate product in the manufacture of light sources with optical front beam guiding elements to constrict the beam divergence and/or to form the beam of light emitters, according to the pre-characterising clause of claim 1.

An intermediate product of this type is known through evident prior use in the form of so-called microlens arrays. Meanwhile, it is possible to manufacture front beam guiding elements from, in particular, silicone material which can be injection-moulded. This material is very expensive. Therefore, until now, it has been impossible to manufacture generic intermediate products economically.

It is therefore an object of this invention to further develop an intermediate product of the above-mentioned type in such a way that even expensive materials for front beam guiding elements can be processed into such intermediate products and, in particular even automated further processing steps become possible. Ideally, it should be possible to manufacture a large number of variants of optical front beam guiding elements economically in one operation by the injection moulding method.

According to the invention, this object is achieved by an intermediate product with the features which are given in the characterising part of claim 1.

According to the invention, it was recognised that it is not absolutely necessary to manufacture the optical front beam guiding elements from the same material as the support. Because according to the invention the support is made of a different material from the front beam guiding elements, the flexibility in forming the material pairing support/front beam guiding elements increases considerably. The support can be made of a less expensive material than the beam guiding elements themselves. This can be used to reduce the costs for the manufactured intermediate product. Particularly when front beam guiding elements made from soft material are used, by using a strong, rigid support material an undesired deformation of the front beam guiding element can be avoided. Also, in the processing of the intermediate product, the light emitters can automatically be joined to the respective holder sections, which are arranged on the support, with the connected front beam guiding elements. By subsequent separation, the end product, i.e. the manufactured light source, can be further processed automatically, e.g. positioned on a printed circuit board. In a reversed joining process, the holder sections which are arranged on the support, with the front beam guiding elements which are joined to them, can first be separated and then automatically mounted on the light emitters. Via the support, even sensitive front beam guiding elements can be mounted on other components. In particular, the intermediate product can be used together with light emitters which emit light of different wavelengths, so that in this way a light mixture can be achieved. In particular, the front beam guiding elements are of a silicone material which can be injection-moulded. The latter has a Shore hardness of up to D 70. Depending on the form of the support, the completed light source can still have support components, in particular a holder of support material, or not. Such support components can be removed before or after the front beam guiding elements with the light emitters are fitted to printed circuit boards.

Holder sections according to claim 2 result in simple mounting either of the light emitters on the intermediate product or of the holder sections with the front beam guiding elements joined to them after they are separated on the light emitter.

Holder sections according to claim 3 elegantly combine two functions, namely holding the light emitters on the one hand and holding the front beam guiding elements on the other hand.

Holder sections according to claim 4 make possible automatic separation of the light sources which are manufactured via the intermediate product by detaching the connecting sections, which in particular are made as break-off places.

Front beam guiding elements according to claim 5 have already proved themselves for constriction of beam divergence. Combinations of corresponding front beam guiding elements are also possible, e.g. a lens which is attached to a metallised support or an optical waveguide with a lens exit objective.

A front beam guiding element according to claim 6 can be manufactured economically.

Front beam guiding elements according to claim 7 can bundle the emission of a large number of light emitters. In this way, applications become practical in which the light emission of a single light emitter is insufficient, or a light mixture is to be achieved by using light emitters which emit different wavelengths.

A support of a material according to claim 8 is particularly stable. Some of these materials are temperature-stable up to 260° C. In association with an appropriate material for the front beam guiding elements, e.g. with transparent silicone material which can be injection-moulded, this results in the possibility of using a subsequent reflow solder bath.

A support according to claim 9 can be manufactured economically.

This also applies to an intermediate product according to claim 10.

An intermediate product according to claim 11 simplifies automation of a manufacturing process in which the intermediate product is used.

A further development according to claim 12 improves the optical properties of the support during operation of the light emitter which is inserted later. Because of the scattered light suppressing or absorbing effect of the holder sections and/or of the main body of the support, a defined illumination characteristic is achieved.

In the case of a front beam guiding element which according to claim 13 is fixed to the support by a catch, holding and connecting sections on the support can be omitted. Alternatively or additionally to the catch connection, the fixing can be done by an interference fit through a corresponding contraction of the support during injection moulding manufacture or by a partial activation of the bonding surfaces between the front beam guiding element and the support. By forming the support according to claim 13, in the manufacture of the light sources in particular, it is possible to avoid the support being exposed to the high temperatures of a reflow solder bath. The support then does not have to be of a material which is resistant to the high temperatures of the reflow solder bath.

An adhesion-activated surface according to claim 14 improves the adhesion of the front beam guiding element to the support. This is particularly advantageous if the support has holder sections which later represent parts of the light sources.

Adhesion-activated surfaces according to claims 15 to 17 can be used in association with mass production of the intermediate products.

An adhesion-activated surface according to claim 18 avoids undesired reinforced adhesion of the support where this is unwanted, e.g. in the area of sprue channels.

The advantages of a support according to claim 19 correspond to those which were explained above with reference to claim 14.

Embodiments of the invention are explained below on the basis of the drawings, in which:

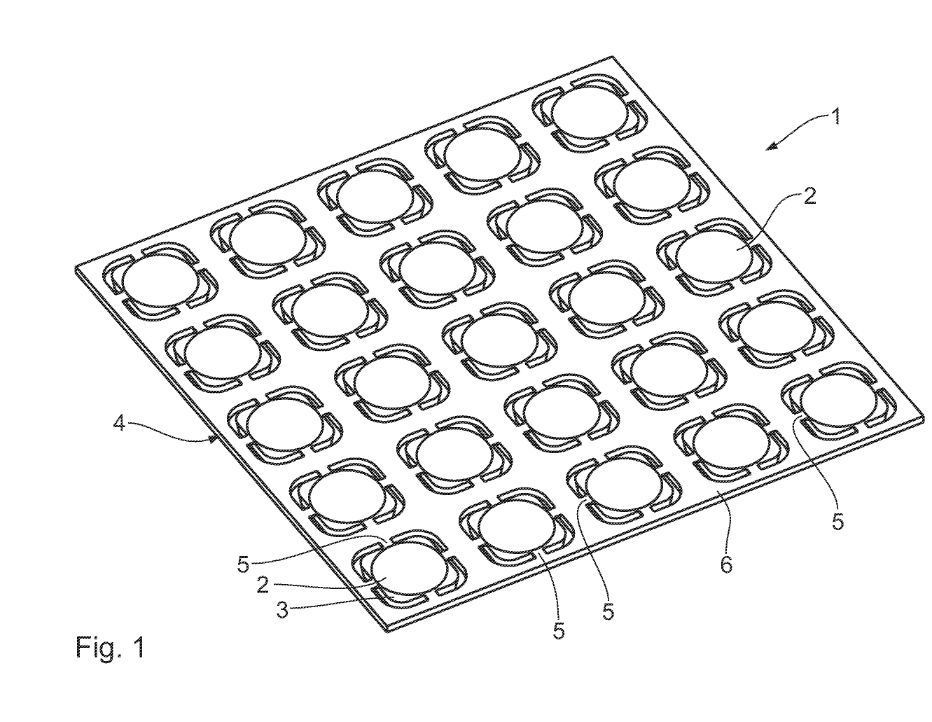

FIG. 1 shows a plan view of an intermediate product for the manufacture of light sources with optical front beam guiding elements to constrict the beam divergence in the form of silicone lenses, seen from the lens side;

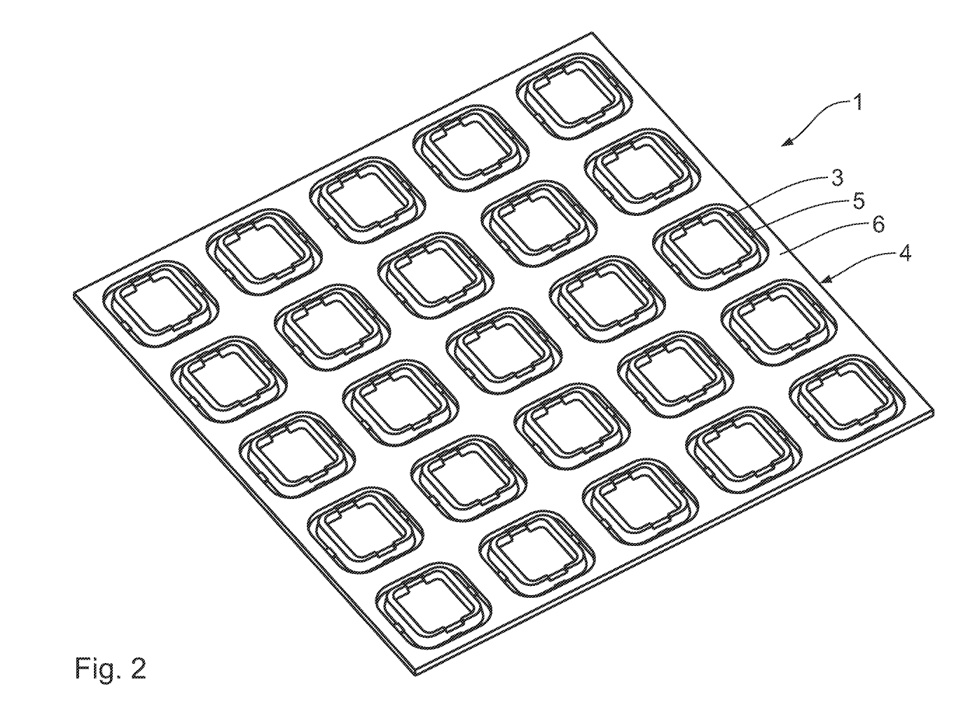

FIG. 2 shows the intermediate product according to FIG. 1 before the light emitters are attached, from the opposite direction compared to FIG. 1;

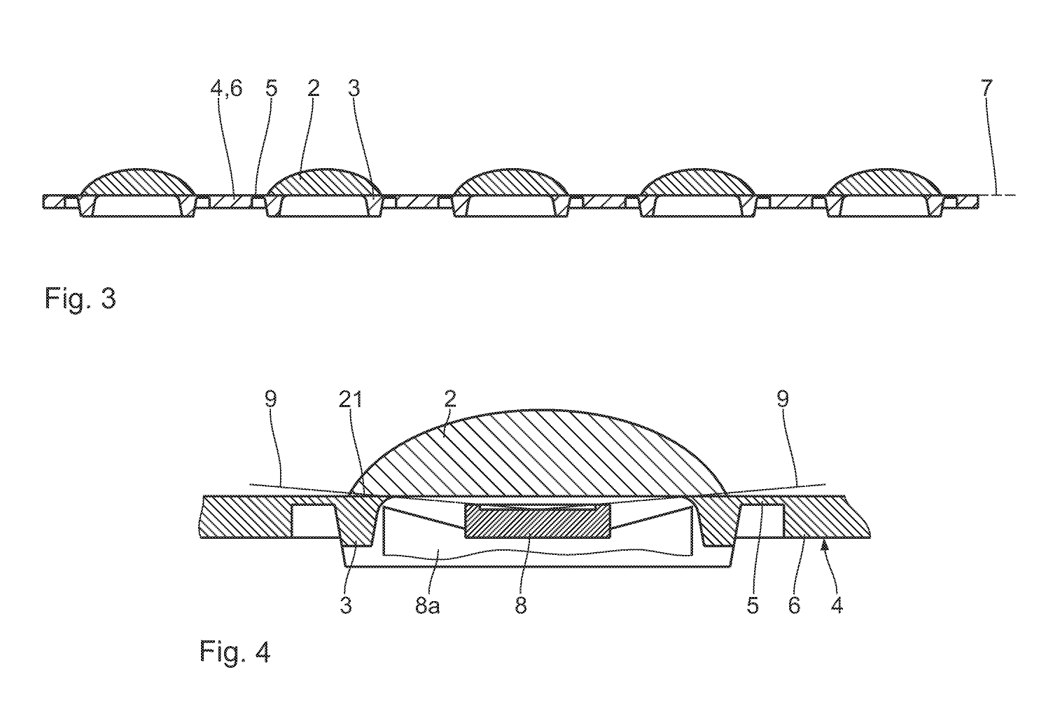

FIG. 3 shows, enlarged and in detail, a section through the intermediate product in the area of five silicone lenses, the section plane running perpendicularly to an array plane which is determined by the intermediate product;

FIG. 4 shows a similar section to FIG. 3, with a light source which is inserted into a holder section of a support of the intermediate product;

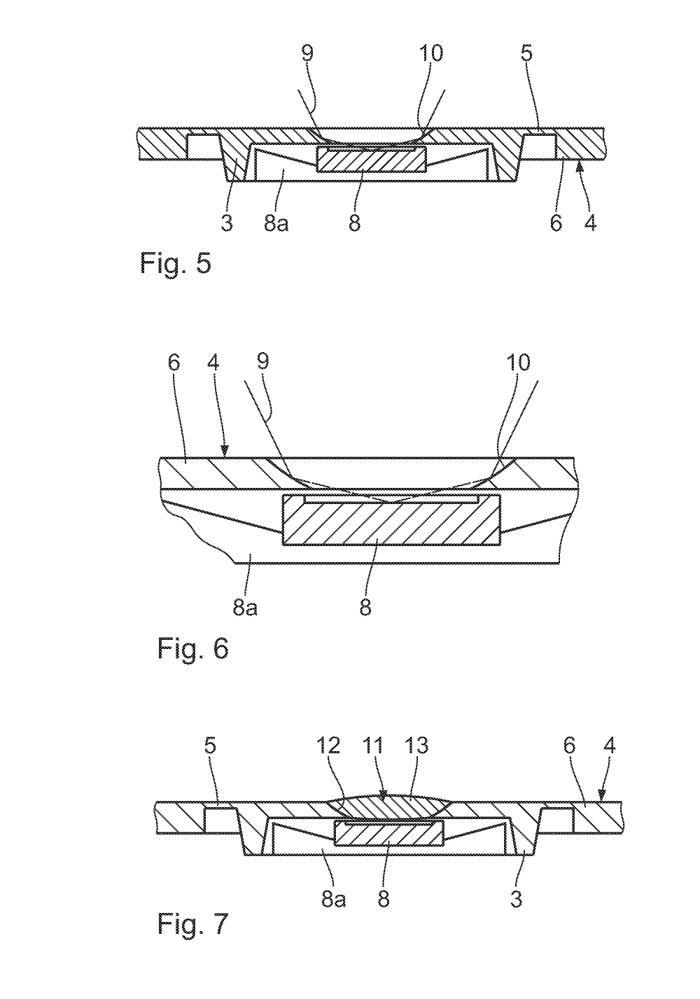

FIG. 5 shows a similar section to FIG. 4, through a further embodiment of an intermediate product with inserted light emitter;

FIG. 6 shows a detail enlargement of FIG. 5, in the area of a reflective front beam guiding element;

FIG. 7 shows a similar representation to FIG. 6 of a further embodiment of a front beam guiding element;

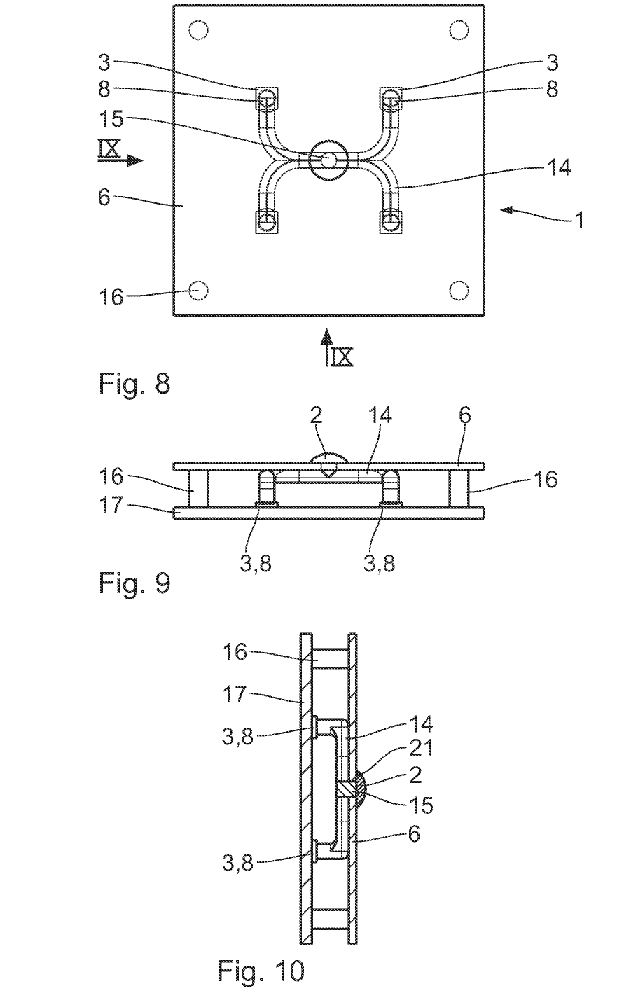

FIG. 8 shows a similar plan view to FIG. 1 of a detail of a further embodiment of an intermediate product;

FIG. 9 shows a side view of the intermediate product according to sight line IX in FIG. 8; and

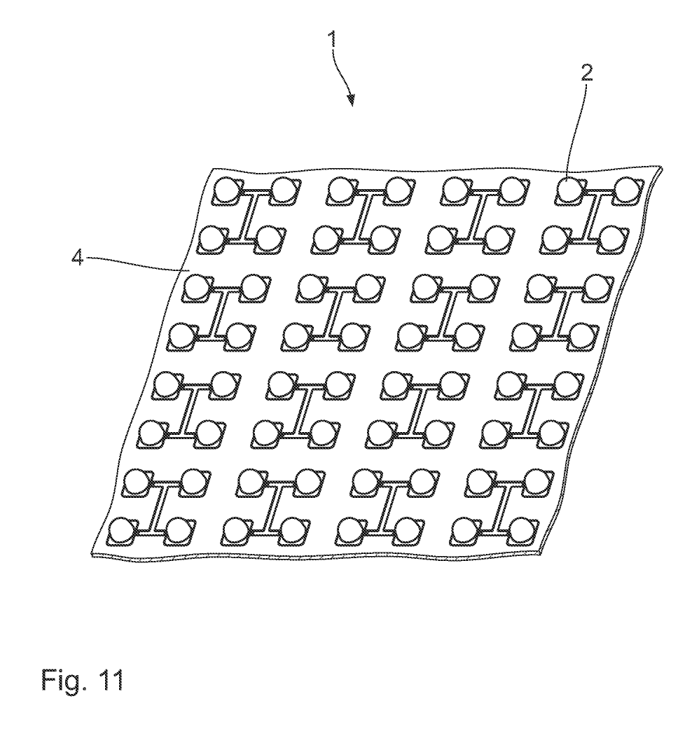

FIG. 10 shows a side view of the intermediate product according to sight line X in FIG. 8;

FIG. 11 is a similar view to FIG. 1 of a further variant of an intermediate product;

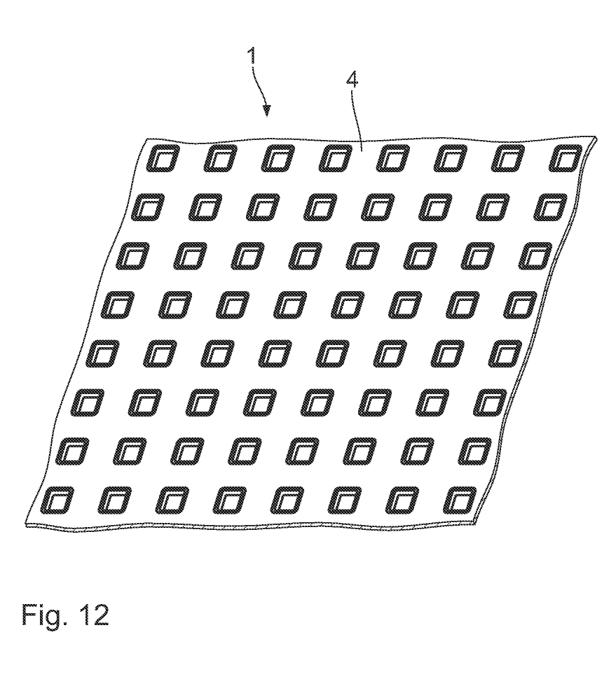

FIG. 12 shows the intermediate product according to FIG. 11, seen in perspective from the opposite side;

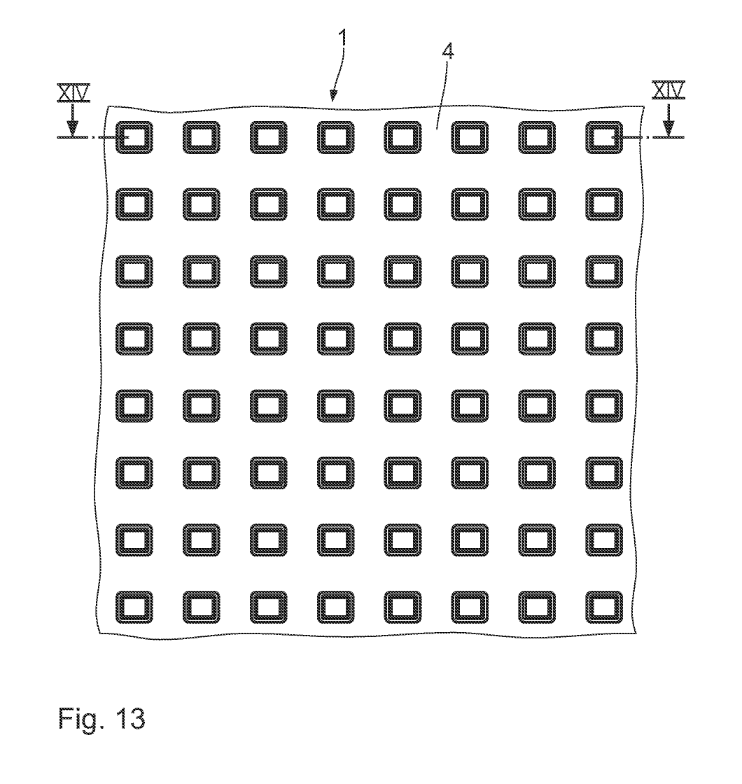

FIG. 13 shows the intermediate product according to FIG. 11 in a plan view, seen from the same side as FIG. 12;

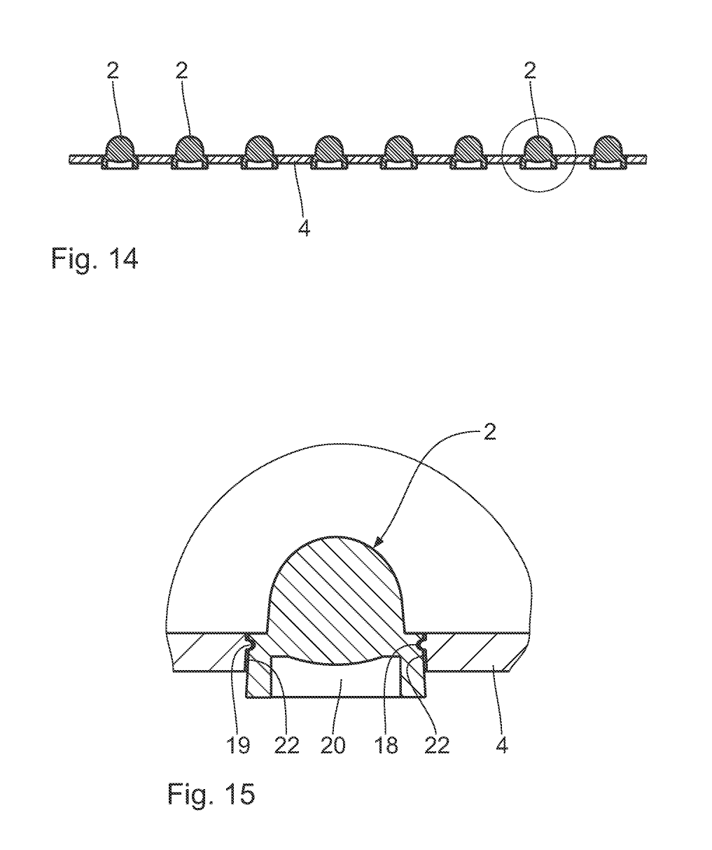

FIG. 14 shows a section according to the line XIV-XIV in FIG. 13; and

FIG. 15 shows a detail enlargement from FIG. 14.

An intermediate product 1, which is shown as a whole in FIGS. 1 and 2, is used in the manufacture of light sources of which the beam divergence must be constricted.

To constrict the beam divergence, front beam guiding elements 2, which in the case of a completely mounted light source are placed in front of the light emitters, are used. In the case of the front beam guiding elements of the embodiment according to FIGS. 1 to 4, these are, for instance, lenses of a silicone material which can be injection-moulded. In total, the intermediate product 1 has twenty five lenses 2, which are arranged as a regular 5×5 array. Other embodiments with other numbers of lenses and arrangements are conceivable. A limitation of the arrangements and/or array sizes results from the size of the injection-moulding machine which is used.

Each lens 2 lies on a holder section 3 of a support 4. The holder section 3 has the form of a ring and a rounded square external cross-section. The external diameter of the lenses 2 is greater than the internal cross-section of the holder section 3, but at the same time less than the external cross-section of the holder section 3. Via connecting sections 5 in the form of four bridges which are associated with each holder section 3, each holder section 3 is joined in one piece to a main body 6 of the support 4. The geometry of the lenses and holder sections and the number and form of the connecting sections can be varied according to the application. The connecting sections 5 are in the form of break-off places, so that the holder sections 3 can easily be removed from the main body 6 of the support.

The support 4 with the holder sections 3 and connecting sections 5 is manufactured from a thermoplastic which is of high strength and rigidity and can be injection-moulded. Examples are a polyetheretherketone (PEEK), a polyphenylene sulphide (PPS) or a partly aromatic copolyamide. The thermoplastic can optionally be glass-fibre-reinforced. LCP (liquid crystalline polymer) is also possible as a material for the support 4.

The array arrangement of the lenses 2 is parallel to a support plane, which in FIG. 3 runs horizontally and perpendicularly to the drawing plane, and is marked 7.

The lenses 2 are joined to the support 4 by two-component injection moulding. Alternatively, manufacture by insertion technology, in which, in a first injection moulding step, the support 4 is formed and then the lenses 2 are injection-moulded via channels in the support 4, particularly by cold channel technology, is also possible.

FIG. 4 shows a detail of the intermediate product 1 after the attachment of a light emitter 8 in the form of a LED. Without the front beam guiding element, i.e. without the lens 2, the LED 8 has a beam divergence of almost 180°. The LED 8 has a LED housing 8a. To attach the LED 8, a thermosetting gel is applied to the underside of the lens 2, and the LED 8 together with the LED housing 8a is put onto it. After the gel has cured, the LED 8 is fixed in the holder section 3 and on the lens 2. The gel is used simultaneously as an index-matching material. Alternatively, the LED can be mounted without gel by positive or non-positive connection of the holder section and/or the lens to the LED body. FIG. 4 shows peripheral beams 9 of the LED 8, the divergence of which is constricted because of the effect of the lens 2.

The intermediate product 1 with fixed LEDs 8 can then be subjected to an electrical bonding step, particularly in a reflow solder bath, if the distances and the arrangement of the lenses 2 with the LEDs 8 on the support 4 correspond to the desired arrangement on a printed circuit board, to which the intermediate product 1 is joined in the bonding step. Following the electrical bonding, the support 4 can be removed, with the exception of the holder sections 3, by breaking off the connecting sections 5. The result is functioning light sources on the printed circuit board. All materials of the intermediate product 1 are resistant to a typical reflow solder bath temperature of 260° C. Alternatively, it is possible, for instance in applications in which matrix illumination is wanted, to feed the support 4 as a whole to its further use. In such applications, the connecting sections can also be omitted, and the holder sections can merge in one piece into the main body of the support.

One and the same support 4 can be used for different forms of the lens 2.

FIG. 5 shows a further embodiment of an intermediate product. Components which correspond to those which were described above with reference to the intermediate product according to FIGS. 1 to 4 carry the same reference numbers and are not explained again in detail.

The intermediate product according to FIG. 5 has as its front beam guiding element a reflector 10. The latter is coated, e.g. by vapour deposition, on a correspondingly concavely curved internal wall of the internal cross-section of the holder section 3. The reflector 10 is a metallic substrate. Depending on the wavelength of the LED 8, the reflector 10 is a gold, silver or aluminium layer. Either the support 4 can be vapour-coated completely with the metallic substrate, or by appropriate masking, partial vapour coating of only the internal walls of the holder sections 3 can take place. Instead of vapour coating, the reflecting coating can be generated galvanically or by an in-mould method (foil back injection).

In FIGS. 5 and 6, two examples of peripheral beams 9 of the LED 8 are shown. The precise position of the peripheral beams 9 depends on the original beam divergence of the LED 8 and the shape of the reflectors 10.

FIG. 7 shows a further embodiment of a front beam guiding element in the form of a beam guiding combination 11 of a reflector 12 according to the type of the reflector 10 of the embodiment according to FIG. 6 and a lens 13 which is attached to it, e.g. cast on or sprayed on. In the case of the beam guiding combination 11, the beam-influencing effects of the reflector 12 and lens 13 are combined.

FIGS. 8 to 10 show a further embodiment of an intermediate product 1 with inserted LEDs 8. Components corresponding to those which were described above with reference to the embodiments according to FIGS. 1 to 7 carry the same reference numbers and are not described again in detail. FIG. 8 shows schematically a detail from the main body 6 of the support in the area of four mutually adjacent holder sections 3 in the form of a 2×2 matrix. This matrix specifies a defined order of the lenses 2. The support plane is parallel to the drawing plane of FIG. 8. Each of the four holder sections 3 is associated with an input optical waveguide section 14. On the input side, the input optical waveguide sections 14 open into the holder sections 3 centrally over the respective LED 8. On the output side, all four input optical waveguide sections 14 combine into a single output optical waveguide section 15. A lens element can optionally be placed on this. The optical waveguide sections 14, 15 are manufactured in one piece from silicone material which can be injection-moulded. Via the optical waveguide sections 14, 15, the light of the four shown LEDs 8 is bundled in the output optical waveguide section 15. The number and arrangement of the LEDs 8 which are bundled in this way can be chosen as required.

In the case of the intermediate product 1 according to FIG. 8, using spacers in the form of spacing pins 16, the main body 6 of the support is distanced from a support board 17, which is arranged parallel to the main body 6 of the support. The optical waveguide sections 14, 15 are arranged between the main body 6 of the support and the support board 17.

Alternatively, a diffractive objective can be used as the front beam guiding element 2.

If required, multiple supports 4 and/or main bodies 6 of the support can be joined together. If required, the support 4, particularly in the area of the holder sections 3, can be coloured black or structured to minimise scattered light, which reduces the proportion of scattered light.

FIGS. 11 to 15 show a further variant of an intermediate product 1, in which no LEDs are yet inserted. Components corresponding to those which were described above with reference to the embodiments according to FIGS. 1 to 10 carry the same reference numbers and are not explained again in detail.

In the case of the embodiment according to FIGS. 11 to 15, holder sections and connecting sections are absent on the support 4. Instead, the front beam guiding elements 2 have undercuts in the form of a surrounding groove 18. The groove 18 of each front beam guiding element 2 engages with a locking element of the support 4 in the form of a complementary surrounding lug 19, to fix the front beam guiding element 2 on the support 4.

In the case of the embodiment according to FIGS. 11 to 15, the front beam guiding element 2 is in the form of a hemispherical lens made from silicone material. A receptacle 20 for one LED per front beam guiding element 2 is in a form corresponding to the receptacle of the embodiment according to FIGS. 1 to 4.

In the case of all the embodiments described above, the support 4, at least on the side facing the front beam guiding elements 2, i.e. where it comes into contact with the front beam guiding elements 2, can have an adhesion-activated surface. Examples of areas of the support surface on which the adhesion-activated surface can be present are surface sections 21 of the support 4 of the embodiment according to FIGS. 1 to 4 and 8 to 10, where the front beam guiding element 2 is placed on the support. In the case of the embodiment according to FIGS. 5 to 7, the surface sections, which are simultaneously used as the reflectors 12, can be adhesion-activated. In the case of the embodiment according to FIGS. 11 to 15, surface sections 22 of the support 4 in which the locking lug 19 is simultaneously formed are the surface areas of the support 4 which can be adhesion-activated.

The adhesion activation of the surface sections 12, 21, 22 can be generated in different ways. The adhesion activation can take place through plasma treatment. Alternatively or additionally, an adhesion promoter or primer can be applied. Adhesion activation is also possible by vapour deposition of a ceramic layer, e.g. Al₂O₃. The following vapour deposition methods can be used: PVD (physical vapour deposition), PCVD (plasma chemical vapour deposition), PICVD (plasma impulse chemical vapour deposition) or PECVD (plasma enhanced chemical vapour deposition).

Alternatively to an adhesion-activated surface, in the case of the described embodiments the whole support 4 can also be formed of an adhesion-activated material. This can be achieved by incorporating additives in the thermoplastic support material. Possible additives include ceramic powder, for instance.

The adhesion-activated surface is preferably present only where the support 4 actually comes into contact with the front beam guiding element 2. Where no adhesion or little adhesion is wanted on the support 4, e.g. in the area of injection sprue channels, there should be no adhesion-activated surface. If the adhesion activation is achieved by a surface coating, this selectivity of the coating can be achieved by using corresponding coating masks, which for instance cover the sprue channel areas.

In the case of the embodiment according to FIGS. 11 to 15, functioning light sources are manufactured correspondingly to what was explained above in relation to the embodiments according to FIGS. 1 to 10.

After the LEDs 8 are fixed to the front beam guiding elements 2 according to FIGS. 11 to 15, the front beam guiding elements 2 can be separated by releasing them from the support 4 and then bonded electrically to a printed circuit board. If the distances and the arrangement of the front beam guiding elements 2 with the LEDs 8 relative to the support 4 correspond to the desired arrangement on the printed circuit board, the front beam guiding elements 2, with the support 4, can be subjected to the electrical bonding step in the reflow solder bath. Subsequently, the support 4 can be removed by releasing it from the undercuts of the front beam guiding elements 2.

The support 4 has to be made from a material which is resistant to the temperatures of the reflow solder bath only if the support 4 or parts of it are actually exposed to the reflow solder bath. In particular, in the case of the embodiment according to FIGS. 11 to 14, this is not so if the front beam guiding elements 2 with the LEDs 8 are separated before the electrical bonding.

1. An intermediate product (1) in the manufacture of light sources with optical front beam guiding elements (2; 10; 12, 13; 14, 15) to at least one of constrict the beam divergence and form the beam of light emitters (8),
with multiple front beam guiding elements (2; 10; 12, 13; 14, 15),
with a support (4), to which the front beam guiding elements (2; 10; 12, 13; 14, 15) are fixed in a defined order,
each of the optical front beam guiding elements (2; 10; 12, 13; 14, 15) being implemented so that it can be attached to a respective light emitter (8),
wherein the support (4) consists of a stronger, more rigid material, compared with the material of the front beam guiding elements (2; 10; 12, 13; 14, 15).

2. An intermediate product according to claim 1, wherein the support (4) has holder sections (3), which are joined in one piece via connecting sections (5) to a main body (6) of the support, to hold the light emitters (8).

3. An intermediate product according to claim 2, wherein the holder sections (3) simultaneously represent holding sections for the front beam guiding elements (2; 10; 12, 13; 14, 15).

4. An intermediate product according to claim 2, wherein the connecting sections (5) have break-off places.

5. An intermediate product according to claim 1, wherein the front beam guiding element (2; 10; 12, 13; 14, 15) includes at least one element from the following group of front beam guiding elements:
lens (2; 13),
diffractive objective,
reflector (10; 12),
optical waveguide (14; 15),
prism.

6. An intermediate product according to claim 1, wherein the front beam guiding element (2; 10; 12, 13; 14, 15) is an injection-moulded component.

7. An intermediate product according to claim 5, wherein the front beam guiding element, which is implemented as an optical waveguide (14, 15), is in such a form that it combines the emission of multiple attachable front beam guiding elements (14).

8. An intermediate product according to claim 1, comprising a support (4) of a thermoplastic material of the following group:
polyetheretherketone (PEEK),
polyphenylene sulphide (PPS),
partly aromatic copolyamide,
liquid crystalline polymer (LCP).

9. An intermediate product according to claim 1, wherein the support (4) is an injection-moulded component.

10. An intermediate product according to claim 9 wherein the front beam guiding elements (2; 10; 12, 13; 14, 15), which are injection-moulded components, with the support (4) are joined to each other by two-component injection moulding.

11. An intermediate product according to claim 1, wherein the front beam guiding elements (2; 10; 12, 13; 14, 15) are arranged in a support plane (7).

12. An intermediate product according to claim 2, wherein at least one of
the holder sections (3) have scattered-light-minimising structures on their side facing the appropriate attachable light emitter (8), and
the main body (6) of the support and the holder sections (3) are manufactured from a material which is absorbent for light of the light emitters (8).

13. An intermediate product according to claim 1, wherein the front beam guiding element (2) has at least one undercut (18), which engages with a locking element (19) of the support (4) to fix the front beam guiding element (2) on the support (4).

14. An intermediate product according to claim 1, wherein the support (4), at least on the side facing the front beam guiding elements (2), has an adhesion-activated surface (12; 21; 22).

15. An intermediate product according to claim 15, comprising a plasma-treated adhesion-activated surface (12; 21; 22).

16. An intermediate product according to claim 15, comprising an adhesion-activated surface (12; 21; 22) which has a primer coating.

17. An intermediate product according to claim 15, comprising an adhesion-activated surface (12; 21; 22) which has a ceramic coating.

18. An intermediate product according to claim 15, wherein the adhesion-activated surface (12; 21; 22) is present only where the support (4) comes into contact with the front beam guiding elements (2).

19. A device according to the invention comprising a support (4) made from an adhesion-activated material.

20. An intermediate product according to claim 11, wherein the front beam guiding elements (2, 10, 12, 13, 14, 15) are arranged in a support plane (7) in the form of a two-dimensional array.
